(19) United States
(12) Patent Application Publication
(10) Pub. No.: US 2026/0191623 A1
(43) Pub. Date: Jul. 9, 2026

(54) COPING IN PARTICULAR FOR PRODUCING A DENTAL IMPRESSION

(71) Applicant: THOMMEN MEDICAL AG, Grenchen (CH)

(72) Inventors: Daniel GREGG, Arch (CH); Sandro FABBRI, Sissach (CH)

(73) Assignee: THOMMEN MEDICAL AG, Grenchen (CH)

(21) Appl. No.: 19/130,756

(22) PCT Filed: Nov. 15, 2023
(86) PCT No.: PCT/EP2023/081849

§ 371 Date: May 16, 2025

(30) Foreign Application Priority Data
Nov. 18, 2022 (EP) 22208262.0

(51) Int. Cl. A61C 8/00

(52) U.S. Cl. CPC A61C 8/0001

(57) ABSTRACT

A coping and adapted additional components for producing an impression, wherein the impression coping has a substantially cylindrical post having a through opening for an axial fixing screw on the implant or on an implant insert. The impression coping has radial widened regions along the cylindrical post, between which widened regions a tapered region is formed. The impression coping has at its apical end at least one contact face for contact with a corresponding contact face on an implant or a corresponding contact face on an implant insert arranged between the impression coping and the implant. In the tapered region, the wall thickness of the impression coping has a predetermined breaking point or, in the closest tapered region facing the apical end, no predetermined breaking point is provided and a tapered region facing away from the apical end has at least one predetermined breaking point.

### TECHNICAL FIELD

The present invention relates to a coping, in particular for producing a dental impression, or else for use as a temporary attachment, as well as corresponding adapted dental components, in particular implants and implant attachments (abutments).

### PRIOR ART

Impression-taking is to be understood as a process step in dentistry and in defect prosthetics. The impression of teeth, jaws and placed implants is used by the dental technician to make the tooth replacement (crown or bridge). Impression-taking is thus producing an impression with the aid of a special compound, typically plastic impression compounds such as, for example, thermoplastic materials or alginate, silicones or gypsum, etc.

What is important is that the impression can be separated from the jaw without either of these being damaged, and that the exact position of the implants, which are normally already incorporated or else have just been placed, is reflected in the impression. It is problematic if the existing and non-replaceable structure from which an impression is to be taken is engaged around and covered not only by the impression compound. On the other hand, it is problematic if so-called impression copings, which are placed onto the implants in order to obtain a corresponding image of the exact position of the implant, are not held exactly in position therein after the removal of the impression compound.

For taking the impression, use is made of thermoplastic and thermosetting materials with, to a certain extent, elastic properties. When the impression is being taken, the impression compound must adapt as well as possible to the surface being molded and subsequently as far as possible no longer change the assumed shape after the impression has been taken.

WO-A-2013/150356 describes a transfer cylinder for dental implants made in one piece, which consists of a body and an insertion part and is characterized in that the insertion part consists of a first head element, which is connected to the body, and of at least one second head element, which is connected to the first head element, wherein the at least one second head element is separable from the first head element, and wherein the first head element has a circular cross section and the at least one second head element has a polygonal cross section, or vice versa.

US-A-2017/165035 describes a two-piece dental-implant fastening bracket having a base portion for the implant fastening bracket at its distal end and having a separate separable snap-on top portion at its proximal end, wherein the top portion has an engagement surface for the insertion tool, a distal cylindrical skirt with a multiplicity of projections on the inner surface of the skirt and a distal insertion projection, wherein the bracket base portion comprises a separable proximal portion having a groove in the vicinity of the bottom of the separable proximal portion for engagement with the projections, a longitudinal passage for receiving a fastening screw for fastening the base portion of the device bracket to a dental implant, and an inner, multi-sided region for engagement with the distal insertion projection with prevention of relative rotation.

### PRESENTATION OF THE INVENTION

What is problematic in this context is that the impression copings provided for the impression must be provided, and kept in storage, in different lengths because of the different spatial conditions, so that the correct impression copings can be used with adaptation to the respective individual conditions.

In this context, it is possible to stock such impression copings only in a maximum length and to appropriately shorten them, by cutting them to the correct length, for example by sawing or grinding in a chip-removing manner, prior to use. It is problematic in this case that these steps have to be carried out prior to the insertion in practice and the cutting process can result both in weakening of the mechanical properties and, in particular due to the corresponding machining steps, undefined sharp edges and the formation of dust in the sterile region. Moreover, residues can remain on the impression coping, which requires renewed cleaning/disinfection shortly before insertion by the user and thus restricts sterile handling. Furthermore, the treatment time is lengthened, in particular in the case of major restorations on multiple implants. It is precisely in this case that the impression is often taken perioperatively, wherein time is not only an economic factor, but also plays a critical role in terms of the care and susceptibility to errors in the process.

The analogous problem arises in the case of temporary attachments (also referred to as temporary implant inserts, temporary restoration attachments or temporary abutments) for producing temporary tooth replacements. These can be connected directly or indirectly (via an implant insert) to the intraosseous dental implant and serve as an aid in prosthetic rehabilitation. Temporary implant inserts can be used before integration of the final tooth replacement in order to maintain, stabilize and shape the soft tissue during the healing phase (soft-tissue conditioning). Temporary implant inserts are used temporarily for a few weeks or months.

If possible, temporary single-tooth or bridge restorations are not in occlusion in order to greatly reduce the burden of chewing forces. Both clinical (no impairment to the incorporation of the implant) and mechanical aspects, such as the strength of the provisional restoration (generally plastics), may be reasons for this.

These temporary attachments, as described above for the impression copings, are also shortened to the required length in situ, and the same/analogue problems arise at the same time.

Pure impression copings serve for determining the implant position (registration of the vertical and horizontal relation) and are predominantly used temporarily. The functional requirements, which differ in comparison with the temporary abutment, are reflected in specific design features:
macroretention configuration
non-load-bearing
material selection

This is where the present invention comes in.

The subject matter of the present invention is accordingly a coping as claimed in claim 1 and accordingly adapted further components, in particular implants and implant inserts adapted and suitable for such copings.

Specifically, according to a first aspect, the present invention relates to a coping, in particular for producing an impression at implant level or at the level of an implant insert in relation to implants already placed, or for use as a temporary attachment.

In this case, the coping has a substantially cylindrical post with a passage opening for at least one axial fastening screw on the implant or on an implant insert. Typically, the coping is screwed onto the implant or an implant insert, which was previously placed onto/into the implant, in that the coping is mounted and the fastening screw is guided through the passage opening and fastened in the implant or to/in the implant insert. After the impression has been taken or after the usage duration of the temporary attachment, these screws are loosened again and the impression can then be removed together with the impression copings and used for further processing, or in the case of the temporary attachment this can be removed and the treatment can be continued.

According to the invention, the coping preferably has along the cylindrical post at least two or three radial widenings, between which at least one or two narrowing(s) is (are) formed. This structuring allows the form fit mentioned in the introduction between the impression compound and the coping, or cold polymer between the temporary attachment and the temporary structure.

Furthermore, a coping according to the invention is characterized in that, at its apical end, that is to say its end which is directed toward the implant, said coping has at least one defined bearing surface for bearing against at least one corresponding bearing surface on an implant or against at least one corresponding bearing surface on an implant insert which is arranged between the coping and the implant. These corresponding and mutually adapted bearing surfaces play a critical role since only then is it ensured that the coping is fastened in a defined manner to the implant or to an implant insert and, after the removal thereof, also reflects the correct spatial orientation and position of the incorporated implant in the impression if used as an impression coping.

In order that the impression can be taken optimally or the temporary means can be configured and fastened optimally in the case of a temporary attachment, the coping should, as mentioned in the introduction, have the correct length.

According to the invention, it is then proposed that at least one of the narrowings of the coping has a predetermined breaking point, normally in the wall thickness between the widenings, wherein the narrowing closest to the apical end preferably has no predetermined breaking point, and/or at least two narrowings of the coping each have at least one predetermined breaking point. It is consequently then possible, while avoiding the above-mentioned disadvantages, to simply set the desired length of the coping in practice and directly in situ, wherein an excessively large length is shortened in that the desired number of widenings are simply snapped off at the predetermined breaking point. This is possible for example simply by hand or else with the aid of small pliers or tweezers or some other device held by hand, second pliers or tweezers or some other device held by hand, or else a corresponding gripping device/clamping device which is provided for example at a table and into which the part to be removed can be fastened or even latched.

In particular, this does not emerge from the above-mentioned WO-A-2013/150356 and is not suggested by it either: That document concerns a component being usable for two different application situations and, for this purpose, the fastening region 3 being equipped with two head elements 3a and 3b following one after the other: In its non-shortened form, the component is used for capturing the orientation of a single implant, for example for a single-tooth restoration, by impression-taking. What is required in this case is a rotation index, the rounded triangle (polygon) on the outer terminal head element 3b. The component is thus used here with both head parts 3a and 3b. If an impression is taken simultaneously at multiple implants, that is to say multiple components are used simultaneously, for example for a bridge restoration, a rotation index hinders the function, specifically the removal of the bridge, in the case of divergent implants. For this use, the outer head element 3b is therefore separated and the component is used with the remaining head element 3a as an interface to the implant without this outer head element 3b. The predetermined breaking point of WO-A-2013/150356 thus serves only to remove the portion 3b, the rotation index, which is functionally limiting for example for a bridge restoration, and not to shorten or shorten in a relatively simple manner the impression coping in order to adapt the height to the for example anatomical conditions. For the purpose of WO-A-2013/150356, it is absolutely necessary for the predetermined breaking point to be arranged in the narrowing closest to the apical end, and there is only one predetermined breaking point.

The predetermined breaking point at the coping proposed here by contrast serves to make it possible for the latter to be shortened in a relatively simple manner, regardless of whether the coping is to be used solely for impression-taking or as a temporary attachment, and also does not serve to make the product usable for different application situations (single teeth vs. bridges).

As proposed here, preferably a narrowing closest to the apical end between two (preferably identical) radial widenings (macroretention) need not have a predetermined breaking point, and/or there must preferably be two predetermined breaking points between respectively two (preferably identical) radial widenings.

A predetermined breaking point is in this case a point in the narrowing of the coping which is determined by a suitable structure, shape or construction (for example a material narrowing) and at which breakage occurs in a predictable manner under load or overload in the region of said narrowing. What may be involved for example is a notch, a perforation or a scoring line, which in the present case results in the situation in which, preferably after the breaking-off, the remaining part, to be mounted onto the implant, of the coping has a defined encircling break-off edge which lies substantially at the same height and which preferably does not have to be reworked.

A predetermined breaking point thus basically serves to ensure that a construction breaks at a certain point in a predictable manner within a defined load range. Here, the predetermined breaking point is determined in a purpose-specific manner by a defined geometrical design, this normally corresponding to a reduction in cross section.

In terms of construction, the predetermined breaking point can be realised inter alia by a so-called notch. In this case, all changes in cross section that interfere with the uniform flow of force are referred to as notches.

The load-bearing capacity of a construction can be reduced significantly by a notch (predetermined breaking point) since the stresses in the surroundings of the interference differ greatly from the calculated nominal cross-sectional stress.

The increase in stress depends on the shape of the notch and on the material.

The advantage of the structural integration of a predetermined breaking point is inter alia that at least two portions can be separated from one another simply by hand or with the aid of non-chip-removing tools, for example pliers, according to design.

For a predetermined breaking point at which breaking-off is intended to be possible with pliers and by hand, the following parameters are typically obtained: for a lever length of L=8 mm, specifically a breaking load F in the range of 10 to 40 N, preferably in the range of 15 to 35 N, is set. These values apply in particular for the use as an impression coping, it being the case that, for the use as a temporary attachment, higher values are also possible or preferred, it specifically being the case that, for these uses, a breaking load F in the range of 20 to 60 N, preferably in the range of 30 to 50 N, is set. Expressed alternatively, the predetermined breaking point is set in such a way as to give rise to a breaking moment in the range of 80 to 320 Nmm, preferably in the range of 120 to 280 Nmm, for the use as an impression coping and, specifically, a range of 160 to 480 Nmm, preferably a range of 240 to 400 Nmm, for the use as a temporary attachment.

An impression cap made of cold-hardened grade 4 titanium with a circular-tube cross section and the notch geometry as per FIG. 7b (predetermined breaking point 37) typically results in the parameters from Table 1:
Remaining wall thickness Breaking load F Lever length L Breaking moment M
0.03 mm 16 N 8 mm 128 Nmm
0.06 mm 32 N 8 mm 256 Nmm

The corresponding parameters are determined as outlined further below.

In the case of two pairs of pliers being used, wall thicknesses larger than those specified in the above section are also possible, and the parameters change if using different materials (for example plastic, aluminum or steel) with the geometry the same. In the case of a coping made of titanium, a wall thickness of 0.3 mm is generally not fallen below. At a predetermined breaking point, for example in the form of an encircling notch, this wall thickness is specifically reduced by preferably 30 to 99%, in particular preferably by 75 to 90%. At a predetermined breaking point, for example in the form of an encircling notch, the preferred remaining wall thickness is specifically in the range of 0.02 to 0.2 mm, in particular is 0.03 to 0.07 mm.

According to a first preferred embodiment, such a coping is characterized in that it has more than two, preferably 3, 4 or 5, radial widenings, there being formed respective narrowings therebetween along the direction of extension of the coping.

Preferably, the radial widenings provided above a first widening that is closest to the apical end (apical foot region) are of identical form, in particular in terms of their shape.

Preferably, with such copings, the narrowings are in the form of rectangular grooves (possibly with rounded edges), which are preferably configured identically for the multiple narrowings.

Preferably, a single predetermined breaking point is in this case arranged in the narrowing arranged at the coronal end or in the second or third narrowing as counted from the coronal end of the coping. With this design, there is in other words exactly one predetermined breaking point, and it is possible to provide the coping in a long variant (used without manipulation) and in a short variant (used after removal of the part that protrudes beyond the predetermined breaking point in the coronal direction).

Preferably, no predetermined breaking point is provided in the narrowing closest to the apical end. The coping may have more than three, preferably 4 or 5, radial widenings, preferably identical radial widenings above a first widening that is closest to the apical end, there being formed respective narrowings therebetween along the direction of extension of the coping, and wherein a respective single predetermined breaking point is arranged in the narrowing arranged at the coronal end or in the second or third narrowing as counted from the coronal end of the coping, or a respective single predetermined breaking point is arranged in the first and the second, or in the second and the third, or in all the narrowings.

A further preferred embodiment of such a coping is characterized in that said coping has more than two, preferably 3, 4 or 5, radial widenings, there being formed respective narrowings therebetween along the direction of extension of the coping, wherein preferably the narrowings are again in the form of rectangular grooves (possibly with roundings at the corner regions), which are preferably configured identically for the multiple narrowings.

Here, it is then preferably the case that provision is made of predetermined breaking points in at least two narrowings, or in at least three narrowings, specifically preferably in at least two of the following narrowings: the narrowing arranged at the coronal end, the second and/or third narrowing as counted from the coronal end of the coping.

Preferably, for example by setting a corresponding minimum wall thickness in the region of the respective predetermined breaking point, the multiple predetermined breaking points are formed in such a way that the force for shortening the impression coping at the predetermined breaking point arranged furthest in the coronal direction is smaller than that at the predetermined breaking points following in the apical direction. This ensures that, with the manipulation of the impression coping, successive shortening occurs and that a situation in which, even though only one segment is to be separated off, separation too far down inadvertently occurs during the very first manipulation is not realized.

According to a further preferred embodiment, the predetermined breaking point is formed in the groove base of the narrowing(s) in the form of a preferably encircling depression. At such a depression as a predetermined breaking point, the wall thickness is preferably reduced by at least 30%, preferably reduced by at least 50%, in particular preferably by at least 70%, in comparison with the remaining wall thickness of the post in the region of the groove base of the narrowing.

Alternatively, it is possible for the predetermined breaking point to be formed in the form of an encircling series of perforations in the form of holes or slots, wherein the perforations may be continuous or else may be formed in the form of a series of blind holes. The holes may in this case be distributed asymmetrically over the circumference, but are preferably distributed uniformly over the circumference, provision being made specifically of 8 to 28 holes, preferably 8 to 16 holes of said type. Provision may also be made of slots, for example two oppositely situated slots or a series of slots. In the case of blind holes, these then preferably have a depth such that the wall thickness at the base is reduced by at least 70%, preferably by at least 80%, relative to the remaining wall thickness of the post in the region of the narrowing.

It is also possible for the predetermined breaking point to be formed as a combination of a preferably encircling depression and series of holes of said type, the holes then preferably being formed in the region of the depression.

Preferably, such an encircling depression is formed adjacent to the apically adjacent widening, so that, if separation occurs there, no post stump projects beyond the widening that is then arranged at the coronal end, the coronal end thus remaining substantially as a face after the separation.

Preferably, the predetermined breaking point in the form of an encircling depression is formed so as to be sectionally
of semi-circular shape (including corresponding oval shapes), of rectangular shape (including square shapes), or of triangular shape, preferably in the last case with an apex directed toward the axis and with a flank parallel to and adjoining the radial flank of the apically adjacent widening and with a flank which widens in the coronal direction, preferably with a rounded base.

Typically, such a coping is characterized in that the wall thickness of the post at the predetermined breaking point is less than the wall thickness in the region of the narrowing of the post at this point, and is formed to a thickness at the thinnest point of less than 0.3 mm, preferably less than 0.2 mm, in particular preferably at most 0.15 mm, at most 0.10 mm or at most 0.05 mm, preferably in the range of 0.03 and 0.07 mm (titanium, encircling notch). If there are multiple predetermined breaking points, the remaining minimum wall thickness at the respective predetermined breaking point is preferably configured so as to increase from the coronal end, so that the separating force increases from the coronal end to the apical end, for example in that the predetermined breaking point arranged furthest coronally has a remaining wall thickness of 0.05 mm, the predetermined breaking point in the next depression that then follows in the apical direction has a remaining wall thickness of 0.10 mm, and the predetermined breaking point in a depression that follows that is arranged furthest in the apical direction has a remaining wall thickness of 0.15 mm.

Typically, such a coping consists of a plastic (also in glass-fiber-reinforced form) or a metallic material, in the latter case preferably of titanium (grade 4 titanium) or a corresponding alloy, preferably a titanium alloy or aluminum alloy (for example titanium/aluminum/niobium or titanium/aluminum/vanadium), and wherein the impression coping preferably has an outer diameter in the range of 1 to 12 millimeters, in particular preferably in the range of 2.5 to 7 millimeters, and the passage bore, in the coronal portion, has an inner diameter in the range of 1-5 millimeters, in particular preferably in the range of 1.5-3 millimeters.

Typically, such a coping is characterized in that the passage bore has in the apical direction a narrowing, preferably encircling shoulder which is provided as a stop for a corresponding narrowing of the fastening screw. This ensures that the fastening screw does not fix the coping at the coronal end surface, but rather in the passage bore via the corresponding encircling shoulder, so as to ensure a more precise fastening close to the implant.

At its apical end, the coping has preferably at least one bearing surface for bearing against at least one corresponding stepped and/or conical bearing surface on an implant, preferably in combination with a shaping in the blind hole of the implant and a corresponding shaping at the coping for preventing rotation of the coping relative to the implant (for example polygonal, for example hexagonal, cross-sectional surface).

Alternatively, at its apical end, the coping has at least one bearing surface for bearing against at least one corresponding stepped and/or conical bearing surface on an implant insert which is arranged between the coping and the implant and which is screwed into a blind hole of the implant.

According to a further embodiment, the predetermined breaking point, before the use, for example in the impression-taking process, is suitable for being used to shorten the coping to a specific length using a gripping tool, preferably using pliers, in that portions of the coping that are arranged coronally from the respective predetermined breaking point can be removed by being broken off.

The present invention furthermore relates to a coping as described above in combination with an accordingly corresponding implant which is intended for bearing directly against the coping,
or in combination with an accordingly corresponding implant insert which is intended for bearing directly against the coping and/or with an accordingly corresponding implant which is intended for bearing directly against the implant insert.

The present invention furthermore relates to a method for forming an impression or a temporary attachment, characterized in that at least one coping as described above is mounted onto at least one inserted implant either directly or via an implant insert and is connected with a fastening screw guided through the passage opening,
in the case of the use as an impression coping a plastic molding compound is put over the impression coping so as to form a form-fitting connection between the impression coping and the plastic molding compound and is formed thereon,
and subsequently the fastening screw is removed and the impression is used to form a tooth structure,
wherein, for setting the suitable length of at least one coping prior to the direct or indirect fastening thereof to the implant, it is shortened to a specific length with the aid of the predetermined breaking point without the use of a chip-removing tool.

Finally, the invention also describes an implant insert which is suitable and adapted for use with a coping as described above and which has corresponding bearing surfaces and outer contours that are intended for bearing directly against the coping, and an implant which is suitable and adapted for use with a coping as described above and which has corresponding bearing surfaces and outer contours that are intended for bearing directly against the coping.

Further embodiments are specified in the dependent claims.

### BRIEF DESCRIPTION OF THE DRAWINGS

Preferred embodiments of the invention will be described below on the basis of the drawings, which serve merely for illustration and are not to be interpreted as being limiting. In the drawings:

FIG. 1 shows a coping in the form of an impression coping according to a first exemplary embodiment for use with an implant insert, wherein, in a), a side view in the state connected to the implant is illustrated, in b), a side view in which the screw and the impression coping are illustrated separately but the implant insert is fastened in the implant is illustrated, and, in c), a side view with a partial section on the right-hand side is illustrated;

FIG. 2 shows the impression coping as per FIG. 1 on its own in a perspective view in a) obliquely from above and in a side view in b), and in c) an illustration of the manipulation of the impression coping with the aid of the predetermined breaking point;

FIG. 3 shows an impression coping according to a further exemplary embodiment with three predetermined breaking points, wherein, in a), a perspective exploded illustration is given, in b), a perspective quarter-section view obliquely from above is given, and, in c), a perspective view of the impression coping on the implant is given;

FIG. 4 shows an impression coping according to the further exemplary embodiment in FIG. 3 in different views, in a) in a perspective view obliquely from above, in b) in a side view, in c) in a quarter-section side view, and in d) in a perspective quarter-section view obliquely from above;

FIG. 5 shows a coping in the form of a temporary attachment according to a further exemplary embodiment with a foot portion that widens in an apical direction, wherein, in a), a side view is illustrated, in b), a quarter-section side view is illustrated, and, in c), a quarter-section side view of the mounted coping is illustrated;

FIG. 6 shows an impression coping according to a further exemplary embodiment that is screwed directly onto the implant, wherein, in a), a quarter-section side view is illustrated, in b), a quarter-section side view in a state mounted onto the implant and fixedly screwed is illustrated, and, in c), an exploded illustration in a side view is illustrated;

FIG. 7 shows various preferred details of this exemplary embodiment, wherein, in a), the details for an impression coping with multiple predetermined breaking points are illustrated, and, in b)-e), different designs of the predetermined breaking points are given in each case in a quarter-section side view;

FIG. 8 shows different designs of predetermined breaking points on the basis of an example of an impression coping, wherein the impression coping is illustrated top left in a side view prior to the breaking, the impression coping is illustrated middle left after the top part has been broken off, and a perspective view of such an impression coping where breaking-off has occurred is illustrated at the bottom, and wherein, in a)-f), different variants of the predetermined breaking points are illustrated on the basis of perspective views of the predetermined breaking point where breaking-off has occurred;

FIG. 9 shows a structure for determining the moments and forces at the predetermined breaking point.

### DESCRIPTION OF PREFERRED EMBODIMENTS

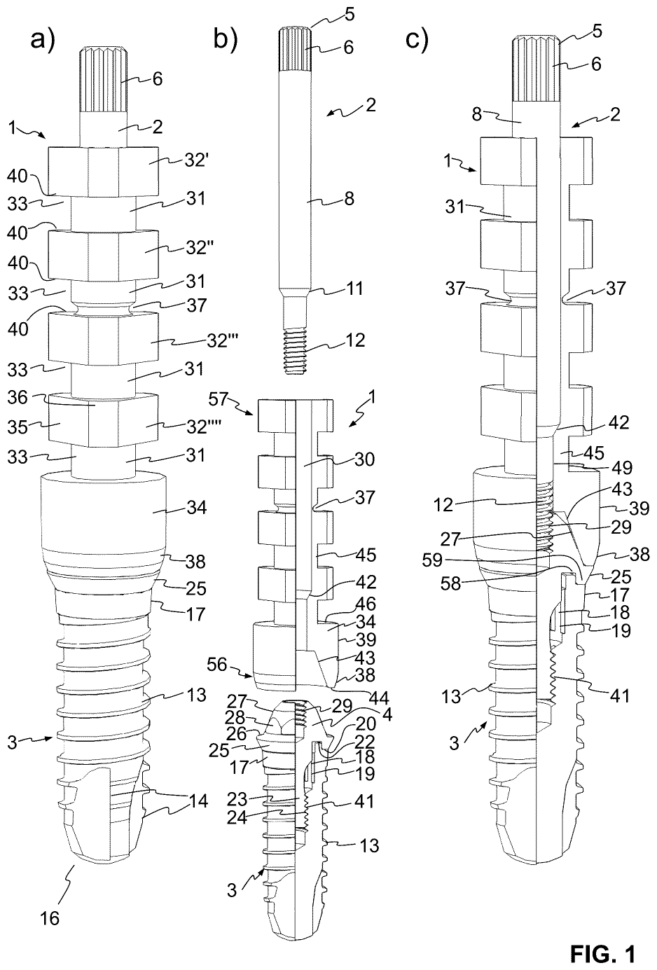

FIG. 1 depicts an impression coping 1 according to a first embodiment in different illustrations.

The impression coping 1 has a cylindrical post 31 which is provided over the length of the impression coping 1 with a series of radial widenings 32, 34. Specifically, from the coronal end 57, there are four such widenings 32′-32″″ and, between these widenings 32, which are basically of identical configuration, there is formed a series of narrowings 33 in the form of encircling rectangular grooves. The apical end is terminated by a final widening in the form of the apical foot region 34.

In other words, the outer diameter of the actual post 31 substantially widens in the region of these widenings 32, the radius typically increasing in these regions by approximately at least 0.5 mm.

At its apical end 56, that is to say its end directed toward the implant 3, the impression coping has an apical foot region 34. This foot region 34 has, first of all, a cylindrical outer surface 39 which transitions at the apical end 56 directed toward the implant into a conically converging transition region 38.

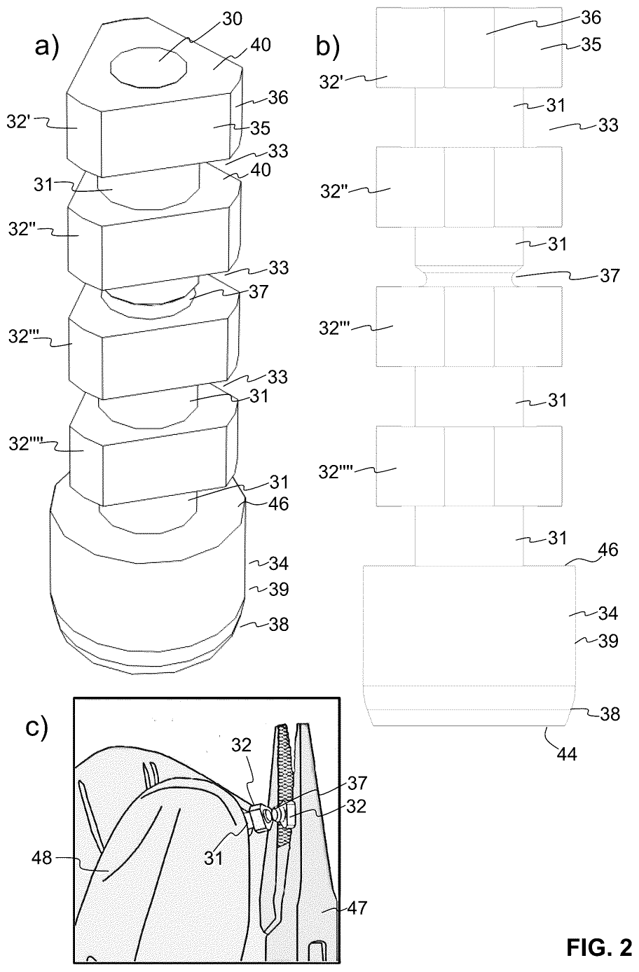

This apical foot region 34, which forms a widening, is, as has been said, formed to be circular cylindrical in cross section, the widenings 32 that follow in the coronal direction by contrast being of approximately triangular form (cf. also FIG. 2), wherein, at the outer contour, they each have planar regions 35 that form a triangle and, therebetween, have curved transition regions 36 between said planar regions 35.

Such an impression coping 1 has a passage opening 30, wherein said passage opening 30 has a relatively large cross-sectional area in the coronal region, and, as part of a shoulder or narrowing 42, which is of conically converging form here, transitions into a narrowed portion 49 with a relatively small diameter.

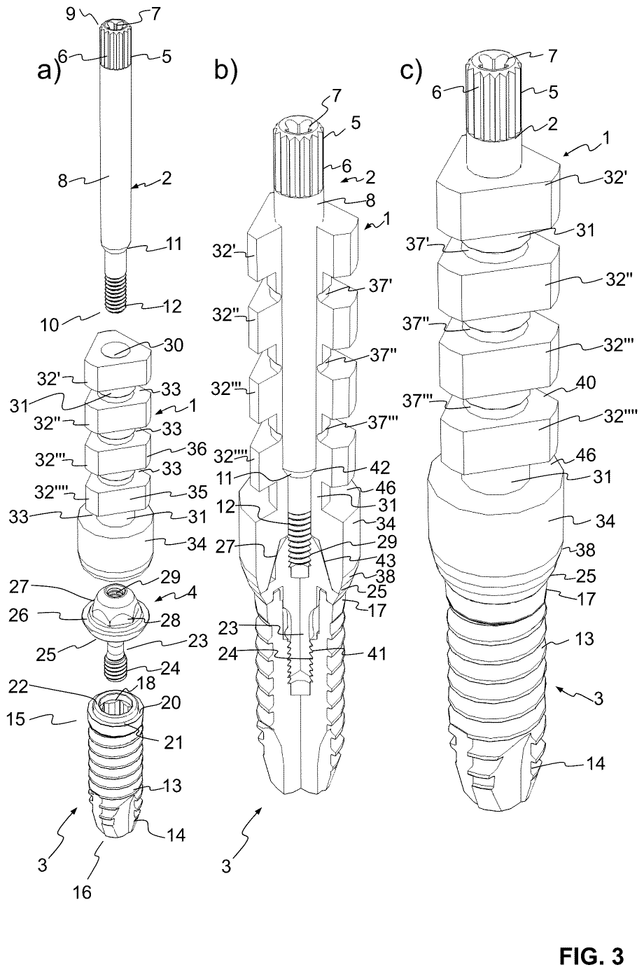

Via this passage opening 30 and the shoulder 42, the impression coping 1 is fastened directly or indirectly to the implant 3. For this purpose, there is a fastening screw 2 having a cylindrical region 8 whose diameter is slightly smaller than the inner diameter of the coronal region of the passage opening 30. At the coronal end, said screw 2 has a holding region 5, which may have on the outer side corresponding outer contours 6, for example to facilitate manipulation by hand, and on the inner side, for example for engagement with a tool, a blind hole with an inner structure 7 (cf. FIG. 3).

At its apical end, the screw has below the apical narrowing 11, which is intended for bearing against the corresponding shoulder 42 in the passage opening 30, an adjoining region with a relatively small diameter, whose outer diameter is slightly smaller than the inner diameter of the region 49 of the passage opening 30. At the apical end of this relatively thin region, provision is made of an external thread 12 as an apical thread.

Such an impression coping 1 is then fastened to an implant 3 using such a screw 2. Here, for example, an implant 3 having a single thread flight in the form of an external thread 13 is illustrated by way of example, wherein, at the apical end 16 of the implant, provision is made of cutting edges 14 in the thread 13. However, in relation to the presently described impression coping 1, the specific outer design of the implant 3 in the apical region is not relevant and may also be different, for example the thread flight 13 may have a different height over the axial direction, and there may also be multiple thread flights.

Above the thread, the implant 3 transitions into a coronal region 17 which has no thread and whose outer contour is substantially cylindrical or widens or narrows slightly in the coronal direction. As is customary, at the coronal end, the implant has a blind hole 18 which has an internal thread 41 in the lower region so that a corresponding structure (abutment or implant insert 4) can be fastened to such an implant 3. Above such a thread 41, there are typically holding structures 19 (these limit all the rotational degrees of freedom and the two translational degrees of freedom in the horizontal plane), for example hexagonal structures, so that for example a crown or an abutment can be fastened in a rotationally conjoint manner in such an implant 3 with the aid of a screw. At the coronal end, said implant 3 then has a stepped structuring, specifically has a shoulder 20 extending radially in the section here, followed by a region extending axially in the section here and, radially at the inside, in turn followed by an end-side terminating surface 22, before the blind hole 18 then begins.

As a transition component to the impression coping 1, provision is then made in this case of an implant insert 4 which, at its apical end, has a pin 23 which, at the very bottom, has an external thread 24 which is intended for engagement into the internal thread 41 in the implant. On the bottom side directed toward the implant 3, said implant insert 4 has a corresponding stepped formation, specifically has an end-side bearing surface 58, which is illustrated radially in the section here and between which an installation clearance corresponding to the surface 22 on the implant 3 is provided, and a bearing surface 59, which is intended for bearing against the end-side surface 20 on the implant, and between said bearing surfaces there is an encircling portion which is illustrated substantially axially in the section here. Thus, via this interface, there is a clearly defined and unambiguous relative position between the implant and the bearing structure defining the implant insert.

At the outer side, the implant insert 4 has an encircling connection flank 25 which is formed so as to widen slightly in the coronal direction and which ensures a smooth transition to the coronal region 17.

As has been mentioned, in a first step, such an implant insert 4 is screwed into the fixed or already even incorporated implant 3 by being screwed into the internal thread 41 of the implant 3 by way of the thread 24. To make this possible, axial hex structures 28 or similar structures are provided in the coronal region of the implant insert 4 so as to allow engagement by a tool. What is important is that, at its coronal end, said implant insert 4 in turn has a blind hole 29 with an internal thread. Moreover, the contour in the upper region is formed as a cone 27 which converges in the coronal direction. Said cone 27 is situated opposite a counterpart cone 43, which is arranged apically adjoining the narrowed portion 49 in the passage bore 30 of the impression coping 1 so as to widen in the apical direction, these two surfaces 27 and 43 not however coming to bear against one another.

The impression coping 1 comes to bear against an end-side stop region 26 of the implant insert 4 by way of its apical end, which is in the form of the end-side apical stop surface 44.

In order that, here too, a smooth transition is ensured at the outer side, the apical foot portion 34 of the impression coping 1 has as a widening a conically converging transition region 38 whose dimensioning is adapted to the connection flank 25 of the implant insert 4.

As can be seen in particular from FIG. 1 c), in the assembled state, the impression coping accordingly bears via the surface 44 against the surface 26 of the implant insert.

A special feature, in particular, is that, in the region of the second-uppermost narrowing section 33, an encircling depression forming a predetermined breaking point 37 is formed in the groove base of the narrowing. This predetermined breaking point 37 may be used, as is illustrated in FIG. 2 c), to adapt to the correct length such an impression coping 1, which must not be too long but also must not be too short, that is to say has to be adapted to the individual conditions, specifically without use having to be made of a cutting disk or some other chip-removing tool. It is simply possible for one region on one side of the impression coping 1 of the region with the predetermined breaking point 37 to be gripped with the aid of pliers 47 or some other clamping tool and for the other side to be gripped for example by hand or with the fingers 48, and the predetermined breaking point is set in such a way that separation is possible there without an excessive application of force. In this case, the predetermined breaking point 37 is arranged at the apical end of the respective narrowing region, so that, after the breaking-off has occurred, the actual cylindrical post 31 protrudes as little as possible above the uppermost widening region, here 32″.

FIG. 2 illustrates such an impression coping 1 with a single predetermined breaking point 37 on its own, specifically in a) in a perspective view obliquely from above and in b) in a side view.

FIG. 3 illustrates an analogous exemplary embodiment, the same reference signs denoting here analogous components as already discussed in relation to FIG. 1 (this applies to the following figures too). The main difference from the exemplary embodiment as per FIGS. 1 and 2 is that, in the exemplary embodiment as per FIG. 3, it is then the case that not only is a predetermined breaking point provided in the second-uppermost depression region 33, but there are three predetermined breaking points 37′, 37″, 37′″ over the length of the impression coping. In this way, not only can the impression coping 1 be provided in a long form and in a short form, but it is possible for there thus to be provided four different lengths, the length without use of a predetermined breaking point, a length at which separation is realized at the predetermined breaking point 37′, a length at which separation is realized at the predetermined breaking point 37″, and a length at which separation is realized at the predetermined breaking point 37′″.

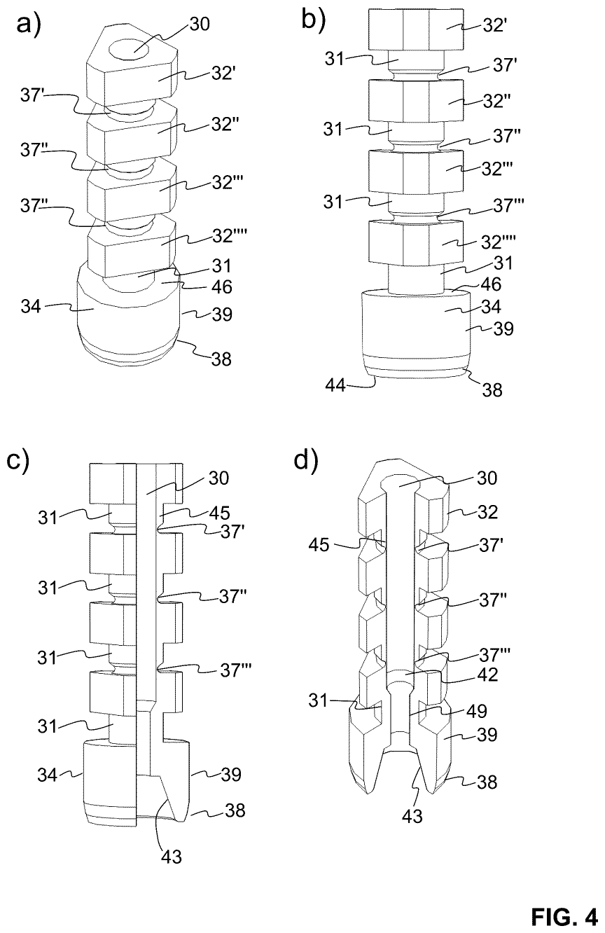

FIG. 4 illustrates the impression coping on its own in further different illustrations according to this second exemplary embodiment.

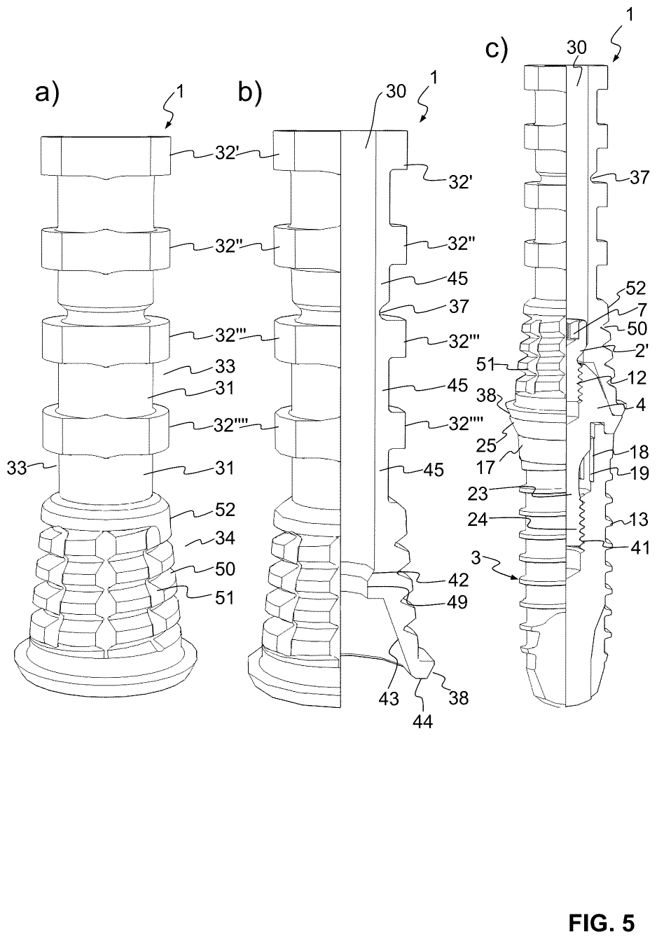

FIG. 5 shows a further exemplary embodiment of a coping, here configured as a temporary attachment, and therefore then having a different configuration of the apical foot region 34 as a widening, but again only with a single predetermined breaking point 37 in the second narrowing region 33, as counted from the coronal side.

Here, the foot region 34 has a cylindrical lateral surface 52 which widens slightly in the apical direction and which, circumferentially, has recesses 50 and additionally has axial recesses 51 (conical threaded groove supplemented by axial recesses). In this case, analogous contact with the implant insert is again ensured by the end-side apical stop surface 44.

Here, however, for fastening purposes, use has then been made not of a long fastening screw 2 that protrudes beyond the coronal end of the coping 1 in the fastened state, but of a short fastening screw 2′ that has to be fastened by a rod-shaped tool by way of engagement into the blind hole 7 through the passage opening 30 and, after use, as a temporary attachment, also has to be loosened again.

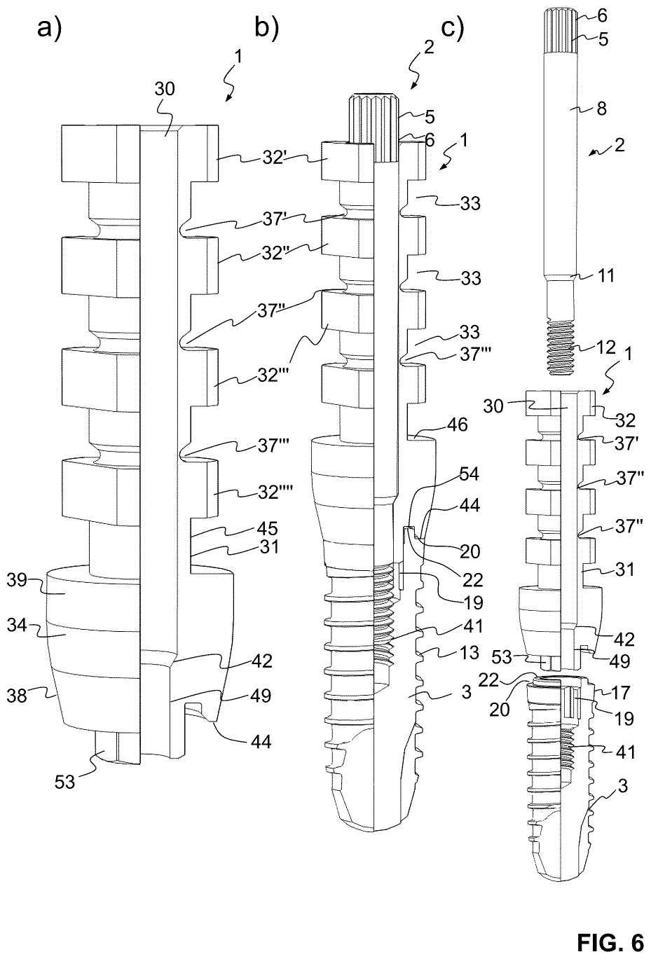

FIG. 6 illustrates a further exemplary embodiment, which is placed directly onto the implant 3 without the interposition of an implant insert. Again here, an embodiment in which there are three predetermined breaking points is involved, although the same is readily possible with only one predetermined breaking point at the position 37″ or else at one of the other predetermined breaking points.

In this case, the foot region 34 of the impression coping has as a widening a relatively short cylindrical region 39 and a relatively long conically converging transition region 38 as an outer contour. Again, however, the design is provided in such a way that the outer contour 38 transitions substantially smoothly into the coronal region 17 of the implant. In this case, a stop surface of the impression coping 1, specifically the stop surface 44, then comes to bear directly against the stop surface 20 of the implant. Moreover, in this case, the impression coping 1 is formed in such a way that its rotational position in relation to the implant is unambiguously defined, specifically in that provision is made of a hex interface 53 for form-fitting engagement into the corresponding axial holding structure 19 in the blind hole 18 in the upper region of the implant 3. Such an impression coping 1 can be fastened using a long screw 2 which protrudes beyond the coronal end of the impression coping, but can also be fastened using a short screw, as illustrated in the context of the exemplary embodiment in FIG. 5.

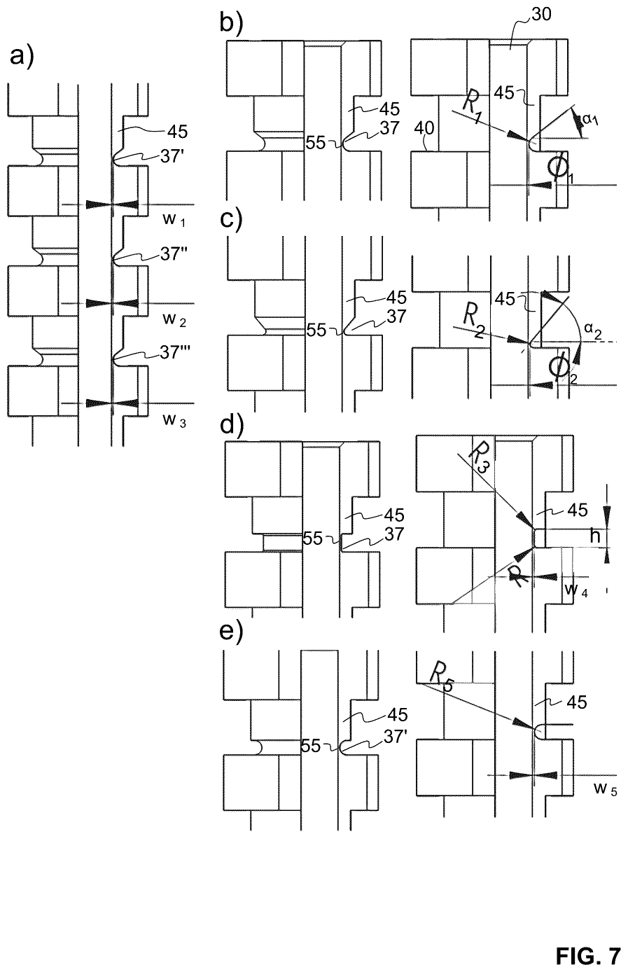

FIG. 7 a) shows the possibility of configuring the breaking force for multiple predetermined breaking points arranged on the same impression coping in a successive manner in terms of breaking force, so as to ensure that excessive shortening does not mistakenly occur, but rather that one element breaks off after the other in succession with increasing breaking moment. This can be ensured in that the wall thickness 45 at the respective predetermined breaking point is set to a minimum remaining wall thickness w₁ that increases along the impression coping from predetermined breaking point to predetermined breaking point in the apical direction. In this regard, it is possible for example to set a wall thickness w₁ of 0.05 mm at the coronal, uppermost predetermined breaking point 37′, a minimum wall thickness of w₂=0.10 mm at the predetermined breaking point 37″ that follows, and a minimum remaining wall thickness w₃ of 0.15 mm at the predetermined breaking point 37′″ that is arranged furthest apically. Other dimensioning is also possible, wherein it must be ensured that the breaking moment increases in the apical direction.

The formation of the predetermined breaking points is possible in different ways. Various configurations of the notch geometry are illustrated in FIGS. 7 b)-e).

FIG. 7 b) shows a substantially triangular groove which is provided in the groove base of the narrowing 33, wherein one flank of the triangle is guided radially inward substantially along the plane 40, is diverted in a large arc, for example with a radius R₁ of 0.2 mm, and then transitions into a further encircling surface, widening radially in the coronal direction, for example at an angle α₁ of 40°. For an inner diameter of the passage opening 30 of 2 mm, the outer diameter of the deepest point in such a groove is then for example arranged at R₁ of 2.1 mm.

An analogue design with a smaller radius, here R₂ of 0.1 mm, is illustrated in FIG. 7 c). The opening angle α₂ is approx. 50° here.

It is also possible (cf. FIG. 7 d) to configure the predetermined breaking point in the form of a rectangular groove with rounded edges, with R₃=R₄, for example 0.05 mm, wherein then a corresponding groove can have a height h of approximately 0.5 mm. The remaining wall thickness w₄ is then typically also 0.05 mm.

Furthermore, FIG. 7 e) shows a predetermined breaking point in the form of a semicircular encircling groove, the narrowed wall thickness 45 also being w₅=0.05 mm here, and the radius R₅ of the semicircular groove being able to be set for example to 0.2 mm.

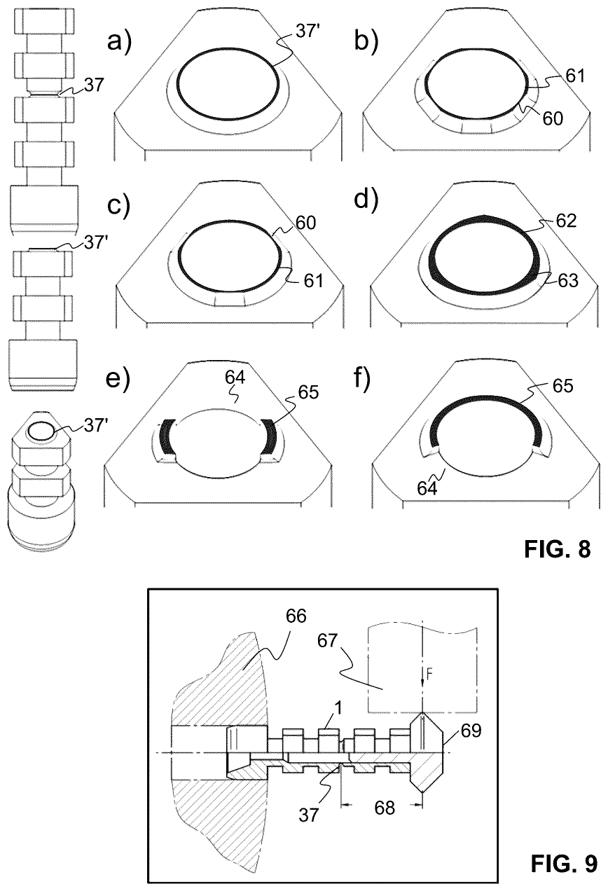

FIG. 8 shows different configurations of the cross-sectional area of the predetermined breaking points.

Illustrated in a) is the variant in which the predetermined breaking point 37′ is in the form of an encircling half-round depression which has the same depth circumferentially.

Illustrated in b) is a variant in which the depression has in a regularly circumferentially alternating manner portions 60 with a relatively small remaining wall thickness and portions 61 with a relatively large remaining wall thickness.

Such a variant is illustrated in c) too, wherein in this case only three relatively short portions 60 with a relatively small remaining wall thickness are formed and the portions 61 with a relatively large remaining wall thickness circumferentially extend to a relatively large extent.

Illustrated in d) is a variant in which the wall thickness varies circumferentially, so that there are thinnest places 62 and thickest places 63. Illustrated in e) is a variant in which the predetermined breaking point is configured in the form of two oppositely situated slots 64, and only two oppositely situated webs 65 remain in between. Such a variant is easy to produce since it is only necessary to cut to length from both sides at the predetermined breaking point as it were, and the result is a preferred bending direction for the cutting to length. Finally, f) shows a variant in which only a single slot 64 on one side is formed and there remains situated opposite a circumferentially extending web 65.

In the case of cold-hardened grade 4 titanium, a circular-tube cross section and the notch geometry as per FIG. 7b (predetermined breaking point 37) result in the measurement values from table 1 presented above. The breaking load of the predetermined breaking point is determined in a static 2-point bending test as illustrated in FIG. 9, wherein the coping 1 is clamped at its apical end into a collet chuck 66, and a test load is applied via a test ram 67 at a test speed of 1 mm/min with a lever arm 68 relative to the predetermined breaking point 37. A test load is applied until breakage. The lever arm 68 between the introduction of the breaking load via the test ram 67 and the predetermined breaking point 37 is provided by way of a corresponding test attachment 69 and is measured using a reflected-light projector. The breaking moment can be calculated from the measured values.

### LIST OF REFERENCE SIGNS

1 Coping, impression coping, temporary attachment
2 Fastening screw
3 Implant
4 Implant insert, abutment
5 Holding region of 2
6 Outer structure of 5
7 Blind hole with inner structure of 5
8 Cylindrical region of 2
9 Coronal end of 2
10 Apical end of 2
11 Apical narrowing of 2
12 Apical thread of 2
13 Thread of 3
14 Cutting edges in 13
15 Coronal end of 3
16 Apical end of 3
17 Coronal region of 3 without a thread
18 Blind hole at the coronal end of 3
19 Holding structures in 18
20 End-side shoulder on 17
21 End-side region of 17
22 Terminating surface of 17
23 Pin of 4
24 Thread of 23
25 Connection flank of 4
26 End-side stop region of 4
27 Cone region of 4
28 Hex structure at the apical end of 27
29 Blind hole with internal thread in 4
30 Passage opening in 1
31 Cylindrical post
32 Widenings of 31
33 Narrowing between 32
34 Widening, apical foot region of 1
35 Planar regions of 32
36 Curved transition regions between 35 of 32
37 Predetermined breaking point in 31 or 33
37′ Broken-off predetermined breaking point
38 Conically converging transition region of 34
39 Cylindrical region of 34
40 Radial flank of 32
41 Internal thread of 3
42 Shoulder/narrowing in 30 for 11
43 Conical inner region at the apical end of 1
44 End-side apical stop surface of 1
45 Wall of 1 in the region of 33
46 Coronal flank of 34
47 Pliers
48 Hand/finger
49 Narrowed portion of 30
50 Encircling recesses in 34
51 Axial recesses in 34
52 Lateral surface of 34, widening
53 Hex interface at the apical end of 34
54 Surface at 34
55 Narrowed wall thickness 45 in the region of 37
56 Apical end of 1
57 Coronal end of 1
58 Surface of 4
59 Bearing surface of 4 at 20
60 Portions of the depression with a relatively small wall thickness
61 Portions of the depression with a relatively large wall thickness
62 Thinnest point of the depression
63 Thickest point of the depression
64 Slot
65 Web of the predetermined breaking point
66 Collet chuck
67 Test ram
68 Lever arm
69 Test attachment
w₁ Wall thickness at 37′
w₂ Wall thickness at 37″
w₃ Wall thickness at 37″

1. A coping for producing an impression at implant level or at the level of an implant insert in relation to implants already placed, or for use as a temporary attachment,
wherein the coping has a substantially cylindrical post with a passage opening for at least one axial fastening screw on the implant or on an implant insert,
and wherein the coping has along the cylindrical post at least three radial widenings, between which at least two narrowings are formed,
wherein, at its apical end, the coping has at least one bearing surface for bearing against at least one corresponding bearing surface on an implant or against at least one corresponding bearing surface on an implant insert which is arranged between the coping and the implant,
and wherein
either provision is made in the at least two narrowings of the coping of in each case at least one predetermined breaking point,
or provision is not made in the narrowing closest to the apical end of a predetermined breaking point and at least one narrowing remote from the apical end has at least one predetermined breaking point.

2. The coping as claimed in claim 1, wherein the coping has more than three radial widenings including identical radial widenings above a first widening that is closest to the apical end, there being formed respective narrowings therebetween along the direction of extension of the coping.

3. The coping as claimed in claim 1, wherein the coping has more than 3, or exactly 4 or exactly 5 radial widenings.

4. The coping as claimed in claim 1, wherein no predetermined breaking point is provided in the narrowing closest to the apical end.

5. The coping as claimed in claim 4, wherein the coping has more than three, or exactly 4 or 5, radial widenings above a first widening that is closest to the apical end, there being formed respective narrowings therebetween along the direction of extension of the coping, and wherein a respective single predetermined breaking point is arranged in the narrowing arranged at the coronal end or in the second or third narrowing as counted from the coronal end of the coping, or a respective-single predetermined breaking point is arranged in the first and the second, or in the second and the third, or in all the narrowings.

6. The coping as claimed in claim 1, wherein the predetermined breaking point is formed in the groove base of the narrowings in the form of a depression, or an encircling series of blind holes, slots or passage bores, or a material weakening, or a combination thereof.

7. The coping as claimed in claim 1, wherein the predetermined breaking point is in the form of a depression, and the wall thickness at the deepest point of the depression is reduced by at least 30% to at most 99%, or reduced by at least 75% to at most 90%, in comparison with the remaining wall thickness of the post in the region of the groove base of the narrowing.

8. The coping as claimed in claim 1, wherein the predetermined breaking point in the form of an encircling depression is formed so as to be sectionally
of semi-circular shape,
of rectangular shape,
of triangular shape.

9. The coping as claimed in claim 1, wherein the wall thickness of the post at the predetermined breaking point is formed to a thickness at the thinnest point less than the remaining wall thickness in the region of the narrowing of the post at this point, and of less than 0.3 mm, or less than 0.2 mm, or at most 1.5 mm, at most 1.0 mm or at most 0.5 mm.

10. The coping as claimed in claim 1, wherein said coping consists of a metallic material.

11. The coping as claimed in claim 1, wherein the passage bore has in the apical direction a narrowing, which is provided as a stop for a corresponding narrowing of the fastening screw.

12. The coping as claimed in claim 1, wherein, at its apical end, the coping has at least one bearing surface for bearing against at least one corresponding bearing surface on an implant,
or wherein, at its apical end, the coping has at least one bearing surface for bearing against at least one corresponding stepped and/or conical bearing surface on an implant insert which is arranged between the coping and the implant and which is screwed into a blind hole of the implant.

13. The coping as claimed in claim 1, wherein the predetermined breaking point, before the use in the impression-taking process or as a temporary attachment, is suitable for shortening of the coping to a specific length by hand or using a gripping tool, in that portions of the coping that are arranged coronally from the respective predetermined breaking point can be removed.

14. The coping as claimed in claim 1
in combination with an accordingly corresponding implant which is intended for bearing directly against the coping,
or in combination with an accordingly corresponding implant insert which is intended for bearing directly against the coping and/or with an accordingly corresponding implant which is intended for bearing directly against the implant insert.

15. A method for forming an impression, wherein at least one coping as claimed in claim 1 is, in the form of an impression coping, mounted onto at least one inserted implant either directly or via an implant insert and is connected with a fastening screw guided through the passage opening,
a plastic molding compound is put over the impression coping so as to form a form-fitting connection between the impression coping and the plastic molding compound and is formed thereon,
and subsequently the fastening screw is removed and the impression is used to form a tooth structure,
wherein, for setting the suitable length of at least one impression coping prior to the direct or indirect fastening thereof to the implant, it is shortened to a specific length with the aid of the predetermined breaking point without the use of a chip-removing tool.

16. The coping as claimed in claim 1, wherein the coping has more than three, or exactly 4 or exactly 5, radial widenings, including identical radial widenings above a first widening that is closest to the apical end, there being formed respective narrowings therebetween along the direction of extension of the coping,
wherein the narrowings are in the form of grooves, which are configured identically for the multiple narrowings, including undercut grooves or rectangular grooves, and wherein a single predetermined breaking point is arranged in the narrowing arranged at the coronal end or in the second or third narrowing as counted from the coronal end of the coping.

17. The coping as claimed in claim 1, wherein the coping has more than 3, or exactly 4 or exactly 5 radial widenings, wherein there are identical radial widenings above a first widening that is closest to the apical end, there being formed respective narrowings therebetween along the direction of extension of the coping,
wherein the narrowings are in the form of rectangular grooves, which are configured identically for the multiple narrowings,
and wherein there are predetermined breaking points in at least two narrowings, or in at least three narrowings, or in at least two of the following narrowings: the narrowing arranged at the coronal end, the second and/or third narrowing as counted from the coronal end of the coping, wherein the multiple predetermined breaking points are formed in such a way that the force for shortening the coping at the predetermined breaking point arranged furthest in the coronal direction is smaller than that at the predetermined breaking points following in the apical direction.

18. The coping as claimed in claim 4, wherein the coping has more than three, or exactly 4 or exactly 5, identical radial widenings above a first widening that is closest to the apical end, there being formed respective narrowings therebetween along the direction of extension of the coping, and wherein a respective single predetermined breaking point is arranged in the narrowing arranged at the coronal end or in the second or third narrowing as counted from the coronal end of the coping, or a respective single predetermined breaking point is arranged in the first and the second, or in the second and the third, or in all the narrowings.

19. The coping as claimed in claim 1, wherein the predetermined breaking point is formed in the groove base of the narrowings in the form of a encircling depression, or a encircling series of blind holes, slots or passage bores, or a encircling material weakening, or a combination thereof.

20. The coping as claimed in claim 1, wherein the predetermined breaking point is in the form of a encircling depression, and the wall thickness at the deepest point of the depression is reduced by at least 30% to at most 99%, or reduced by at least 75% to at most 90%, in comparison with the remaining wall thickness of the post in the region of the groove base of the narrowing.

21. The coping as claimed in claim 1, wherein the predetermined breaking point in the form of an encircling depression is formed so as to be sectionally of triangular shape, with a flank parallel to and adjoining the radial flank of the apically adjacent widening and with a flank which widens in the coronal direction, including with a rounded base.

22. The coping as claimed in claim 1, wherein said coping consists of a metallic material, selected from titanium or titanium alloy, including grade 2, 3 or 4 titanium, titanium/aluminum/vanadium (TAV), titanium/aluminum/niobium (TAN), and wherein the post has an outer diameter in the range of 1-12 millimeters, or in the range of 2.5-7.0 millimeters, and the passage bore, in the coronal portion, has an inner diameter in the range of 1-5 millimeters, or in the range of 1.5-2.5 millimeters.

23. The coping as claimed in claim 1, wherein the passage bore has in the apical direction a narrowing, encircling shoulder which is provided as a stop for a corresponding narrowing of the fastening screw.

24. The coping as claimed in claim 1, wherein, at its apical end, the coping has at least one bearing surface for bearing against at least one corresponding bearing surface on an implant, in combination with a shaping in the blind hole of the implant and a corresponding shaping at the coping for preventing rotation of the coping relative to the implant.

25. The coping as claimed in claim 1, wherein the predetermined breaking point, before the use in the impression-taking process or as a temporary attachment, is suitable for shortening of the coping to a specific length by hand or using a gripping tool, using pliers or tweezers, in that portions of the coping that are arranged coronally from the respective predetermined breaking point can be removed.
